(19) United States
(12) Patent Application Publication
(10) Pub. No.: US 2026/0146885 A1
(43) Pub. Date: May 28, 2026

(54) SYSTEMS AND METHODS FOR MONITORING VIBRATIONAL PATTERNS ASSOCIATED WITH A MOVABLE BARRIER OPERATOR

(71) Applicant: THE CHAMBERLAIN GROUP LLC, OAK BROOK, IL (US)

(72) Inventors: Michael J. Davies, Minneapolis, MN (US); Christian Smith, Vail, AZ (US); Thomas Jason Janovsky, Elgin, IL (US); Christopher J. Staub, Aurora, IL (US)

(21) Appl. No.: 18/960,095

(22) Filed: Nov. 26, 2024

(51) Int. Cl. G01H 1/00; G01M 13/028

(52) U.S. Cl. CPC G01H 1/00; G01M 13/028

(57) ABSTRACT

Systems and methods disclosed herein are directed to monitoring a movable barrier operator. The system includes a movable barrier operator coupled to one or more sensors; one or more processors; and one or more non-transitory computer-readable media that collectively store instructions that, when executed by the one or more processors, cause the computing system to perform operations, the operations comprising: receiving sensor data from the one or more sensors; extracting one or more vibrational patterns from the sensor data; classifying the one or more vibrational patterns into one or more diagnostic categories; generating diagnostic data associated with the movable barrier operator as a function of the classification; and transmitting a notification to a user device as a function of the diagnostic data.

### FIELD

The present disclosure relates generally to systems and methods for monitoring vibrational patterns associated with a movable barrier operator.

### BACKGROUND

Movable barrier operators have long experienced mechanical and electrical issues that affect their performance over time. These issues may not always be immediately apparent through traditional operational checks, leading to delays in detecting faults or potential system failures.

Accordingly, improved systems and methods that facilitate the preemptive identification and quantification of mechanical and electrical faults are desired in the art. In particular, systems and methods for monitoring vibrational patterns associated with a movable barrier operator would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a system for monitoring a movable barrier operator is provided. The system includes a movable barrier operator coupled to one or more sensors; one or more processors; and one or more non-transitory computer-readable media that collectively store instructions that, when executed by the one or more processors, cause the computing system to perform operations, the operations comprising: receiving sensor data from the one or more sensors; extracting one or more vibrational patterns from the sensor data; classifying the one or more vibrational patterns into one or more diagnostic categories; generating diagnostic data associated with the movable barrier operator as a function of the classification; and transmitting a notification to a user device as a function of the diagnostic data.

In accordance with another embodiment, a method for monitoring a movable barrier operator is provided. The method includes receiving, by a computing system comprising one or more processors, sensor data from one or more sensors coupled to a movable barrier operator; extracting, by the computing system, one or more vibrational patterns from the sensor data; classifying, by the computing system, the one or more vibrational patterns into one or more diagnostic categories; generating, by the computing system, diagnostic data associated with the movable barrier operator as a function of the classification; and transmitting, by the computing system, a notification to a user device as a function of the diagnostic data.

In accordance with a third embodiment, a system for monitoring a movable barrier operator is provided. The system includes a movable barrier operator coupled to one or more sensors; one or more processors; and one or more non-transitory computer-readable media that collectively store instructions that, when executed by the one or more processors, cause the computing system to perform operations, the operations comprising: receiving sensor data from the one or more sensors; extracting one or more vibrational patterns from the sensor data; classifying the one or more vibrational patterns into one or more diagnostic categories, wherein classifying the one or more vibrational patterns comprises: iteratively training a vibrational model using vibrational training data, wherein the vibrational training data comprises examples of vibrational patterns correlated to examples of diagnostic categories; and classifying the one or more vibrational patterns into the one or more diagnostic categories using the trained vibrational model; generating diagnostic data associated with the movable barrier operator as a function of the classification; and transmitting a notification to a user device as a function of the diagnostic data.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 depicts a block diagram of an exemplary system for monitoring vibrational patterns associated with a movable barrier operator in accordance with various implementations of the present disclosure.

FIG. 2 depicts a flow diagram of a method for training a vibrational model in accordance with various implementations of the present disclosure.

FIG. 3 depicts a block diagram of a system for generating vibrational synthesis patterns in accordance with various implementations of the present disclosure.

FIG. 4 depicts a flow diagram of a method for monitoring vibrational patterns associated with a movable barrier operator in accordance with various implementations of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than a limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first,” “second,” and “third” may be used interchangeably to distinguish one component from another and are not intended to signify the location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

As used in this disclosure, the term “function” refers to a situation where one piece of data or one variable determines the value of another. For example, if a second data point is generated as a function of a first data point, the value of the second data point is computed, at least in part, based on the value of the first data point, e.g., through a specific algorithm or process. This relationship can be represented mathematically or programmatically, where a function takes the first data point as an input and produces the second data point as an output, thereby establishing a direct dependency between them.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Generally, the present disclosure is directed to systems and methods for monitoring a movable barrier operator. The systems and methods disclosed herein are configured to generate diagnostic data associated with a root cause issue associated with the movable barrier operator. The diagnostic data may be generated based on vibrational patterns that have been extracted from the moveable barrier operator using a sensor. These vibrational patterns may be classified into diagnostic categories associated with various root cause issues. Based on this classification, systems, and methods disclosed herein are configured to generate the diagnostic data.

Systems and methods disclosed herein include receiving sensor data from the one or more sensors. Sensor data may be associated with the vibrational patterns of the movable barrier operator. Specifically, sensor data includes the vibrational patterns produced by the moving components of the movable barrier operator. This may include measuring the vibrational patterns generated by the actuator of the movable barrier operator, wherein the actuator is responsible for operating the movable barrier. By capturing this sensor data, the system can evaluate the primary and secondary characteristics of the vibrational patterns.

Systems and methods disclosed herein include classifying the one or more vibrational patterns into one or more diagnostic categories. Classifying vibrational patterns into diagnostic categories involves analyzing the characteristics of the vibrational patterns to identify specific operational states and potential issues within the mechanical system. These characteristics include but are not limited to frequency, amplitude, and waveform characteristics.

In an embodiment, the classification of the vibrational patterns may involve differentiating between normal, warning, and fault conditions based on the characteristics of vibrations. Normal vibrational patterns may exhibit consistent frequencies and amplitudes, indicating that the system is functioning smoothly. When vibrations start to exceed baseline thresholds, this can be categorized as a warning condition, suggesting the presence of issues such as misalignment or wear that may require closer monitoring. If the vibrations exhibit erratic patterns or significantly increased amplitudes, they can be classified as fault conditions, indicating that immediate intervention may be necessary to prevent system failure.

Machine-learning models may be employed to enhance the process of classifying the one or more vibrational patterns into one or more diagnostic categories. The machine-learning models may be trained on historical vibrational data. This training data is used to help the machine-learning model learn to recognize patterns associated with specific diagnostic categories.

Systems and methods disclosed herein include generating diagnostic data associated with the movable barrier operator as a function of the classification. Diagnostic data refers to the information related to the operational health of a movable barrier operator. The diagnostic data is used to provide insights into potential mechanical or electrical issues through analysis of the vibrational patterns. This may be done with the goal of correlating specific vibrational signatures with known root causes.

With reference now to the Figures, example embodiments of the present disclosure will be discussed in further detail.

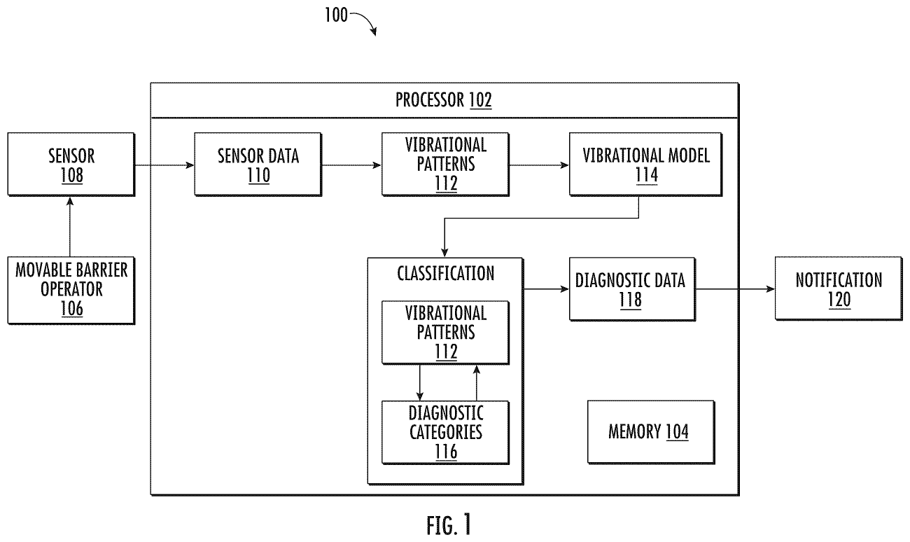

FIG. 1 depicts a block diagram of an exemplary system 100 for monitoring vibrational patterns associated with a movable barrier operator. System 100 includes processor 102, memory 104, moveable barrier operator 106, sensor 108, sensor data 110, vibrational patterns 112, vibrational model 114, vibrational patterns 112, diagnostic 116, diagnostic data 118, notifications 120, and the like.

System 100 includes one or more processors 102 that can be utilized to perform one or more operations. The one or more processors 102 can include any suitable processing device (e.g., a processor core, a microprocessor, an ASIC, a FPGA, a controller, a microcontroller, etc.) and can be one processor or a plurality of processors that are operatively connected. The one or more processors 102 can perform operations in series and/or in parallel. The one or more processors 102 may be dedicated to a particular computing device and/or may be utilized by a plurality of devices to perform processing tasks. In an embodiment, processor 102 could be situated within each of these various computing devices, such as remote computing devices, user devices, laptops, smartphones, smart watches, tablets, computing systems associated with the movable barrier operator, and the like. One or more of these computing devices may be employed to handle specific processing tasks and operations.

Processor 102 may be designed and/or configured to perform any method, method step, or sequence of method steps in any embodiment described in this disclosure, in any order and with any degree of repetition. For instance, processor 102 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. This may be used to train, refine, or otherwise improve any model, algorithm, machine-learning model, neural network, and the like mentioned herein.

Processor 102 may include a single computing device operating independently or may include two or more computing devices operating in concert, in parallel, sequentially, or the like; two or more computing devices may be included together in a single computing device or in two or more computing devices. Processor 102 may include but is not limited to, for example, a computing device or cluster of computing devices in a first location and a second computing device or cluster of computing devices in a second location. Processor 102 may include one or more computing devices dedicated to data storage, security, distribution of traffic for load balancing, and the like. Processor 102 may distribute one or more operations as described below across a plurality of computing devices, which may operate in parallel, in series, redundantly, or in any other manner used for the distribution of tasks or memory between computing devices.

System 100 may include memory 104 which can store data and/or instructions. Memory 104 can include one or more non-transitory computer-readable storage mediums, such as RAM, ROM, EEPROM, EPROM, flash memory devices, magnetic disks, etc., and combinations thereof. The data can include user data, application data, operating system data, etc. The data can include text data, image data, audio data, statistical data, latent encoding data, etc. The instructions can include instructions that when executed by one or more of the processors 102 may cause system 100 to perform operations as described herein.

Memory 104 may store data and/or instructions associated with one or more applications. The one or more applications can include native, factory-set applications and/or downloaded applications. The applications may include one or more messaging applications, one or more image capture applications, one or more social media applications, one or more productivity applications, one or more map applications, one or more device management applications, one or more browser applications, and the like. In some implementations, the applications can include one or more applications communicatively connected to one or more server computing systems for providing access to a platform. For example, the applications can include an application for monitoring vibrational patterns associated with a movable barrier operator.

System 100 includes one or more movable barrier operators 106. As used in the current disclosure, a movable barrier operator 106 refers to a mechanical device that controls the opening and closing of a movable barrier. This may include movable barriers such as gates, garage doors, doors, locks, and the like. The movable barrier operator 106 may be configured to actuate the movable barrier between two or more positions to selectively allow people, goods, and/or vehicles access to a secured area. In a non-limiting example, the movable barrier operator 106 may include a garage door opener and/or an actuator used to move a gate or barrier arm. In an embodiment, the movable barrier may include one or more garage doors, automated locks, alarm systems, lift gates, sliding gates, automatic doors, and/or other controllable devices.

### PROCESSING THE SENSOR DATA TO ONE OR MORE VIBRATIONAL PATTERNS

With continued reference to FIG. 1, the operations further comprise receiving sensor data 110 from the one or more sensors 108. As used in the current disclosure, sensor data 110 refers to the quantitative measurement of the vibrations within one or more portions of the moveable barrier operators 106. Sensor data 110 may be used to detect vibrational characteristics such as frequency, amplitude, and patterns of vibrations as the movable barrier operator 106.

The one or more sensors 108 may be mechanically affixed to one or more motors and/or mechanical components of the movable barrier operator 106. This may include attaching the one or more sensors 108 to a drive train, motor, or other mechanical component of the movable barrier operator 106. In an embodiment, the one or more sensors 108 may be mechanically attached to a rotating part of the drive train, such as a gear, shaft, or pulley. In an embodiment, the one or more sensors 108 can be mechanically attached to a barrier, such as a barrier arm, a barrier wall, or the like. In some instances, the barrier includes multiple segments and the sensors 108 are arranged with at least one sensor 108 on at least two of the segments. For instance, barrier arms may be split between two arm segments to permit articulation when the barrier arm is raised and lowered. The sensors 108 can be split between the segments with a first sensor disposed at a first arm segment and a second sensor disposed at a second arm segment. Placement of the sensors 108, i.e., determining location of the sensors 108, may be predetermined. For example, some barriers may include predetermined sensor attachment locations. The sensor attachment locations can be marked, for example, by a label or bounding indicia. In some instances, the barrier may include multiple predetermined sensor attachment locations but less than all of the predetermined sensor attachment locations are actively used at a given time. For example, the predetermined sensor attachment locations can include three predetermined sensor attachment locations spaced apart from one another. During installation or assembly, one or two sensors 108 are attached to the barrier at less than all three predetermined sensor attachment locations. In this regard, some of the predetermined sensor attachment locations may not be used. The location for placing the sensor(s) 108 (either at one or more of the predetermined sensor attachment locations, randomly, or using another placement method) can be determined in view of anticipated vibration and/or area(s) of interest. For example, some installations may be anticipated to incur a certain type of vibration that is best detected by placing the sensor in a corresponding location of the barrier while other installations may be anticipated to incur a different type of vibration that is best detected by placing the sensor in a different corresponding location of the barrier. Thus, the one or more sensors 108 can be placed as a function of the anticipated type of vibration to be detected. In some instances, at least one of the sensors 108 is externally mounted such that the sensor 108 is visible and/or accessible without removing any portion of the structure to which the sensor 108 is attached. In other instances, at least one of the sensors 108 is embedded in the structure to which it is attached.

The one or more sensors 108 may include exemplary vibrational sensors such as accelerometers, piezoelectric sensors, vibration transducers, and the like. Accelerometers may be used to measure the acceleration forces acting on a mechanical component of the movable barrier operator 106. Piezoelectric sensors may be configured to generate an electrical charge in response to mechanical stress, such as vibrations. In some embodiments, vibration transducers may be used to convert mechanical vibrations into electrical signals. These transducers can measure various vibrational characteristics, such as frequency, amplitude, and overall vibration levels.

With continued reference to FIG. 1, the operations further comprise extracting one or more vibrational patterns 112 from the sensor data 110. As used in the current disclosure, vibrational patterns 112 refer to frequencies or oscillations that can be observed in physical systems, such as the movable barrier operator 106. These vibrational patterns 112 may include distinct characteristics and signatures of vibrations that are identified and extracted from sensor data 110. These vibrational patterns 112 may be characterized by specific frequencies, amplitudes, and waveforms that occur during the operation of the movable barrier operator 106. Yet other types of vibrational pattern characterization is contemplated herein.

Extracting the one or more vibrational patterns 112 may include preprocessing the sensor data 110. Preprocessing the sensor data 110 may include removing the noise from the raw sensor data 110 provided by the sensor(s) 108. This may be done by applying one or more filtering techniques to the sensor data 110. For instance, low-pass filtering can allow signals below a certain frequency threshold to pass through while attenuating higher frequencies. This may be done to remove high-frequency noise that can obscure the lower-frequency vibrational patterns of interest. Conversely, high-pass filtering serves to remove low-frequency drifts and trends.

Preprocessing the sensor data 110 may include data normalization. Variability in amplitude can occur due to differences in sensor sensitivity or changes in operational conditions. Normalization adjusts the data to a common scale, ensuring that amplitude variations do not skew the analysis. This could involve rescaling the data to a range between 0 and 1 or using z-score normalization, which standardizes the data based on its mean and standard deviation.

System 100 may apply a Fast Fourier Transformation (FFT) to the sensor data 110. As used in the current disclosure, FFT is a mathematical algorithm that transforms time-domain data, which represents how the vibrations change over time, into frequency-domain data. This transformation is useful because it allows system 100 to analyze the frequencies present in the vibrational patterns. Time-frequency analysis methods, such as wavelet transforms, may also be employed to capture non-stationary signals where frequency characteristics change over time.

After the sensor data 110 has been preprocessed, feature extraction techniques may be used to identify the primary characteristics of the vibrational patterns 112. This may include identifying primary characteristics such as frequency, amplitude, waveform, and the like. In some cases, feature extraction techniques may be used to identify specific patterns or shapes associated with the vibrational patterns, such as sinusoidal, complex waveforms, periodic, and/or aperiodic. Additionally, vibrational patterns 112 may show nodes, points of minimal displacement, and antinodes, where maximum movement occurs.

Processor 102 may extract vibrational patterns 112 using a machine-learning model that is configured to analyze sensor data 110 and identify relevant vibrational patterns 112. Inputs to the machine-learning model may include sensor data 110, time-series signal data, extracted vibrational characteristics such as frequency and amplitude, and various contextual parameters. The outputs of the model may include vibrational patterns 112.

The training data for the machine-learning model may include a plurality of data entries containing a plurality of inputs that are correlated to a plurality of outputs for training a processor by a machine-learning process. This training data may include diverse signal samples and associated vibrational characteristics. In an embodiment, the training data may be stored in a training data database. The training data may encompass information about various signal features and examples of extracted vibrational patterns. In one embodiment, the training data may be iteratively updated based on the input and output results from a previous iteration of the machine-learning model or any other relevant machine-learning models mentioned throughout this disclosure.

### CLASSIFYING THE ONE OR MORE VIBRATIONAL PATTERNS INTO ONE OR MORE DIAGNOSTIC CATEGORIES USING A VIBRATIONAL MODEL

With continued reference to FIG. 1, the operations involve classifying the one or more vibrational patterns 112 into one or more diagnostic categories 116. As used in the current disclosure, diagnostic categories 116 refer to distinct classifications that group together various primary and secondary characteristics of the vibrational patterns 112. These categories serve as a means to link specific features of the vibrational patterns 112 to potential root cause issues encountered in moveable barrier operators 106. In one embodiment, each diagnostic category 116 is associated with a particular set of primary and/or secondary characteristics that are indicative of specific root cause issues or malfunctions within the moveable barrier operators 106. These primary characteristics can include frequency, amplitude, or other quantifiable attributes of the vibrational patterns 112. The secondary characteristics may include but are not limited to the installation date, make and model of the movable barrier operators, frequency of use, size and weight, geography, weather, and the like. To provide further clarity and precision, each of these characteristics may be assigned diagnostic scores, which are used to quantify the severity of each characteristic.

Exemplary diagnostic categories 116 may include categories for mechanical wear, misalignment, track obstruction, electrical issues, load imbalance, weather, heavy nearby passing traffic, impact from a vehicle or nearby object, and the like. The mechanical wear category may refer to a category of vibrational patterns 112 associated with the wear and tear of mechanical components such as gears, bearings, drive trains, and components of the drive systems. The misalignment category may refer to a category of vibrational patterns characterized by misalignment in mechanical parts, leading to inefficient operation or increased friction. The load imbalance category may refer to a category of vibrational patterns that are associated with uneven weight distribution that can cause stress and affect the operator's performance. The weather category may refer to forces from wind, passing groundwater, or built-up accumulation of snow, ice, or the like.

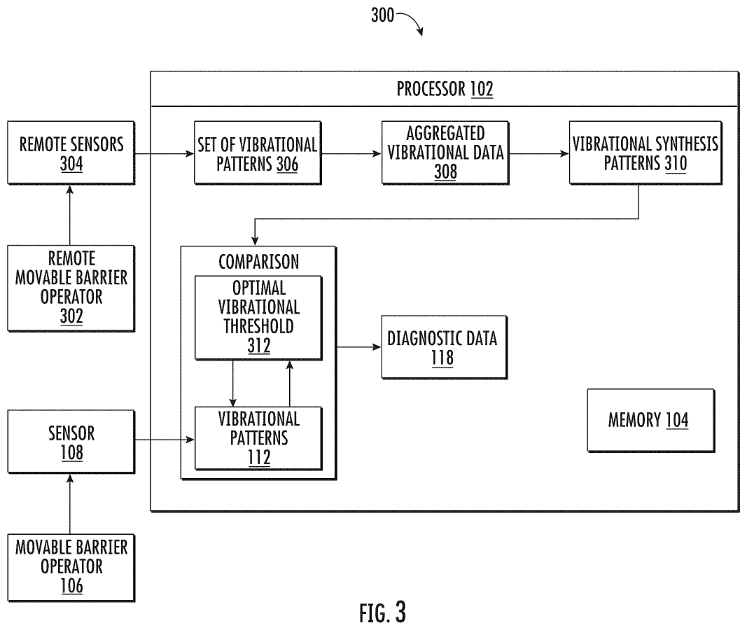

With continued reference to FIG. 1, classifying the one or more vibrational patterns may include generating a set of diagnostic scores as a function of the one or more vibrational patterns 112. As used in the current disclosure, diagnostic scores are used to quantify the characteristics of the vibrational patterns 112. These scores are derived from an analysis of the primary and secondary characteristics of the vibrational patterns. The scores provide a structured way to evaluate the vibrational patterns 112 relative to established benchmarks or optimal vibrational threshold 312, as discussed in greater detail herein below with reference to FIG. 3.

By comparing the observed vibrational patterns 112 to baseline or optimal vibrational threshold 312 (FIG. 3), the processor 102 may generate diagnostic score(s) that reflect the severity and type of behavior detected. The diagnostic score(s) aggregate the vibrational characteristics into a numerical value or range, where higher scores typically indicate normal or healthy operation, and lower scores suggest deviations that may require further investigation. For example, if the movable barrier operator's 106 vibrational patterns fall within established optimal ranges, the diagnostic score will be high, indicating that the system is functioning correctly. If the data deviates from these ranges, the score will decrease, suggesting that a mechanical issue or maintenance need may be present. However, if the diagnostic score reflects deviations from normal behavior, the vibrational pattern can be assigned to one of several diagnostic categories 116 that indicate potential problems.

In a non-limiting example, a low diagnostic score that reflects an increase in friction or irregular vibration may be classified under the misalignment category, indicating that some part of the system is out of alignment. On the other hand, a pattern that shows signs of irregular vibrations due to uneven weight distribution could be categorized under load imbalance, pointing to a mechanical issue that might affect the operator's performance.

With continued reference to FIG. 1, classifying the one or more vibrational patterns 112 may include mapping the one or more vibrational patterns 112 to at least one vibrational synthesis pattern 310 from a plurality of vibrational synthesis patterns. This may be done by evaluating the characteristics of the one or more vibrational patterns 112 using any method discussed herein. This may include evaluating the characteristics of the one or more vibrational patterns 112, as quantified by the diagnostic scores, against the characteristics of the vibrational synthesis patterns 310. By comparing the diagnostic scores, the system can identify correlations between the observed vibrational behavior and specific operational issues.

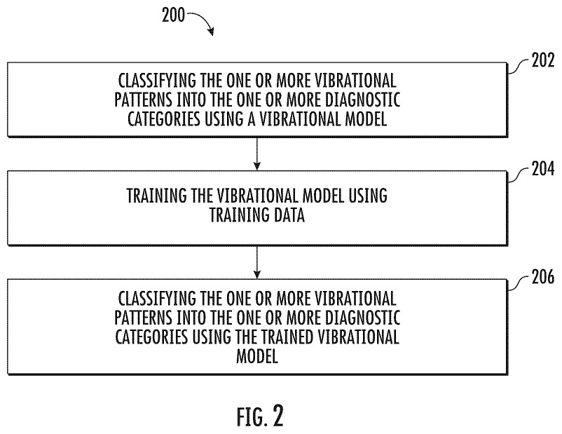

Referring now to FIG. 2, an exemplary flow diagram of a method for training a vibrational model is depicted. At step 202, the method includes classifying one or more vibrational patterns 112 into one or more diagnostic categories 116 using a vibrational model 114. As used in the current disclosure, the vibrational model 114 is a data structure representing and/or instantiating a mathematical and/or algorithmic representation of a relationship between vibrational patterns 112 and diagnostic categories 116. The vibrational model 114 may be trained to classify the vibrational patterns 112 into one or more diagnostic categories 116 based on their physical characteristics. This vibrational model 114 may evaluate the primary and secondary characteristics of the vibrational patterns 112 to identify the diagnostic category 116 that is suitable for the vibrational pattern. This may include any physical characteristics that are present within the sensor data 110. These physical characteristics may include but are not limited to frequency, amplitude, phase, harmonic content, energy content, and the like. For example, if a vibrational pattern 112 reflects a singular event with a large energy content the vibrational model 114 may be configured to classify the vibrational pattern 112 to an impact diagnostic category 116. In some cases, the vibrational model 114 may utilize machine-learning techniques to analyze the primary and secondary characteristics and determine vibrational patterns that correspond to specific diagnostic categories 116.

At step 204, the method includes training the vibrational model using the training data. The training of vibrational model 114 may serve to establish correlations that the machine-learning processes can utilize to model relationships between various categories of data elements. The training data may include numerous exemplary or historical vibrational patterns. The vibrational model 114 analyzes this training data to establish correlations between the characteristics of the vibrational patterns and the identified issues associated with the diagnostic categories 116.

The training data includes multiple entries, each representing a collection of recorded, received, or generated data points. The data elements are often correlated through their shared existence within individual entries, their proximity to one another, or other relevant criteria. By analyzing these correlations, the vibrational model 114 can discern trends, such as the relationship between specific vibrational characteristics and the diagnostic issues they indicate.

The training data may be structured to highlight the correlations between the characteristics of the vibrational patterns and the identified issues associated with the diagnostic categories 116. For example, higher values of certain physical characteristics might correlate with specific diagnostic categories 116, suggesting a proportional or mathematical relationship between them. By structuring the training data according to the diagnostic categories, the vibrational model 114 can effectively learn and recognize patterns.

Moreover, the training data may also include elements that are not explicitly categorized. In such cases, machine-learning algorithms can automatically sort the data by employing techniques like correlation detection. The machine-learning model can generate diagnostic categories 116 based on the inherent relationships found within the data.

In some cases, refined training examples may be selected from a broader population to ensure that they are representative of the various scenarios the vibrational model may encounter. This selection process aims to cover a range of likely inputs, ensuring the vibrational model 114 can generalize well when deployed. The chosen training example may reflect a statistically determined distribution, ensuring that more frequently encountered values are represented proportionally within the training data. If any potential training examples are identified as missing, the system can automatically generate these entries by creating correlations within existing data or generating synthetic training data.

Training the vibrational model 114 may include iteratively updating various parameters, such as coefficients, biases, and weights, based on error evaluations and expected outcomes. This process may include generating an output from the vibrational model 114 using a specific input example from the training data. The vibrational model's 114 output is then compared to the corresponding output from the training example, leading to the creation of an error function. This error function quantifies the difference between the predicted and actual values. This may be done by calculating the square of the difference between these values.

Once the error function is established, it may be utilized to adjust the vibrational model's 114 parameters through techniques like gradient descent or least-squares optimization. This iterative tuning process involves gradually refining the weights, biases, and coefficients of the model based on the calculated error. This is done to help improve the vibrational model's 114 accuracy in classifying vibrational patterns.

The iterative updates continue until the training data is exhausted or a convergence test is achieved. A convergence test assesses whether the model has reached an acceptable level of accuracy, often by comparing the differences between successive error values. When these differences fall below a predefined threshold, it indicates that the model has stabilized, and further training may yield diminishing returns. Additionally, errors from training iterations can be compared to a threshold to determine if the model's performance has met the desired criteria for accuracy.

At step 206, the method includes classifying the one or more vibrational patterns into the one or more diagnostic categories using the trained vibrational model. Once the vibrational model 114 is trained, it can utilize classification algorithms to assign vibrational patterns 112 to the most relevant diagnostic categories 116. By employing techniques such as support vector machines, decision trees, machine-learning algorithms, or neural networks, the vibrational model 114 assesses the similarity between incoming vibrational patterns and those it has learned during the training phase. This evaluation process may involve evaluating the distances or similarities within a multidimensional feature space.

### GENERATING DIAGNOSTIC DATA ASSOCIATED WITH THE MOVABLE BARRIER OPERATOR AS A FUNCTION OF THE CLASSIFICATION

With continued reference to FIG. 1, the operations include generating

diagnostic data 118 associated with the movable barrier operator 106 as a function of the classification. As used in the current disclosure, diagnostic data 118 is data that describes the mechanical health of the movable barrier operator 106. The diagnostic data 118 may provide insights into potential mechanical or electrical issues through vibrational analysis. The classification process enables the model to correlate specific vibrational signatures with known problems. In some cases, diagnostic data 118 may include secondary characteristics of the vibrational patterns, such as operational conditions at the time of data collection, frequency of use, and environmental factors.

In an embodiment, the diagnostic data 118 may include information about the mechanical or electrical issues associated with the movable barrier operator 106. This may include information related to the nature and severity of the problem, possible causes, and recommended maintenance actions. In a non-limiting example, if a vibrational pattern 112 is classified under a category indicating mechanical wear, the associated diagnostic data 118 might include metrics like the extent of wear, affected components, and suggested timelines for repairs or replacements.

Referring now to FIG. 3, an exemplary block diagram of a system for generating vibrational synthesis patterns is depicted. FIG. 3 depicts a remote movable barrier operator 302, remote sensor 304, set of vibrational patterns 306, aggregated vibrational data 308, vibrational synthesis patterns 310, optimal vibrational threshold 312, and the like.

System 300 includes a plurality of remote sensors 304 connected to a plurality of remote movable barrier operators 302. As used in the current disclosure, the term remote is used to describe an object that is situated away from System 100 in terms of physical distance or location. The term remote may apply to a variety of mechanical and electrical components that operate away from system 100. These components include but are not limited to processors, movable barrier operators, sensors, along any other mechanical component mentioned herein. Components that are classified as remote may exhibit characteristics that are the same or substantially similar to their non-remote counterparts. For example, a remote movable barrier operator 302 refers to a movable barrier operator that is located away from movable barrier operator 106 by some physical distance.

System 300 may perform operations that include receiving sets of vibrational patterns 306 from a plurality of remote sensors 304 connected to a plurality of remote movable barrier operators 302. As used in the current disclosure, a set of vibrational patterns 306 refers to a collection of distinct vibrational patterns 112 that are gathered from the plurality of remote sensors 304. These vibrational patterns can be generated by the operational activities of the movable barrier operators 302. These operational activities may include opening and closing motions, mechanical strains, or any disturbances that could generate vibrational patterns during the operation of the movable barrier operators 302.

The operations may include generating aggregated vibrational data 308 as a function of the set of vibrational patterns 306. As used in the current disclosure, aggregated vibrational data 308 refers to a dataset formed by structuring the set of vibrational patterns 306. The aggregated vibrational data 308 can represent a structured version of the unstructured sets of vibrational patterns 306. Structuring the unstructured sets of vibrational patterns 306 can include sorting the vibrational data into one or more diagnostic categories 116, as discussed herein above. A model similar to the vibrational model 114 may be used to organize these vibrational patterns into their distinct diagnostic categories 116. In some cases, structuring the sets of vibrational patterns 306 may include categorizing the vibrational patterns 306 based on various criteria, such as operational states, environmental factors, installation date, operation frequency, geography, weather patterns, and the like.

Categorizing the unstructured sets of vibrational patterns 306 can also include clustering each individual vibrational pattern 306 into one or more clusters. Clustering may involve grouping individual vibrational patterns based on the similarities of their primary or secondary characteristics. This allows for the identification of distinct operational behaviors among the plurality of movable barrier operators 302. In an embodiment, each cluster may represent a group of vibrational patterns that share similar primary characteristics, such as frequency, amplitude, and duration. In some cases, the clusters may be associated with the one or more diagnostic categories 116. System 300 can also categorize the vibrational patterns 306 into clusters that represent secondary characteristics related to the movable barrier operators 302.

Additionally, System 300 can also cluster the vibrational patterns 306 based on the orientation of the movable barrier operator 302 (i.e. vertical or horizontal). The operational dynamics of these different types of movable barriers can significantly affect their vibrational characteristics. For example, horizontal barriers may experience different stressors than vertical ones during operation.

Structuring the individual vibrational patterns 306 may facilitate the synthesization of the vibrational patterns 306 into the aggregated vibrational data 308. This may be done by evaluating the characteristics of the vibrational patterns using various statistical methods. Statistical methods may include calculating the mean and standard deviation of the vibrational patterns. Based on the statistical analysis, system 300 can establish typical operating ranges for the vibrational patterns associated with each movable barrier operator 302. Identifying these ranges may allow the system to identify normal operational behavior. Additionally, the system may be configured to flag deviations from the normal operational behavior that may indicate potential issues or anomalies in performance. In some cases, the diagnostic score may be used to evaluate the characteristics of the vibrational patterns 306.

In addition to evaluating the vibrational patterns 306 using statistical methods, system 300 may employ trend analysis to monitor changes in vibrational patterns over time. This method can enable the detection of gradual shifts in the data, providing insights into how the performance of each movable barrier operator 302 changes with time and environmental conditions. For example, if the trend analysis reveals a consistent increase in the average vibration amplitude six years after installation, this may indicate a critical data point for determining when maintenance should be performed.

In an embodiment, system 300 may employ a machine-learning model to generate the aggregated vibrational data 308. The machine-learning model may be trained on training data composed of historical aggregated vibrational data or any other data discussed herein. By training on historical data, the machine-learning model can learn to recognize patterns and relationships within the vibrational patterns, enabling it to classify, cluster, and structure the sets of vibrational patterns 306 into aggregated vibrational data 308. The training data may be labeled according to operational states, frequency of use, installation dates, make and model, horizontal orientation, vertical orientation, and any other primary and secondary characteristics of the vibrational patterns 306 discussed herein. In some cases, the machine-learning model may be trained in the same or substantially similar manner as the vibrational model 114.

Training the machine-learning model may involve multiple iterations where the model is exposed to the labeled training set. During each iteration, the model will analyze the features and characteristics of the set of vibrational patterns 306. The machine-learning model will then create correlations based on the labeled characteristics of vibrational patterns represented in the training data. The biases and weights of the machine-learning model may be iteratively adjusted using one or more optimization algorithms. This may be done so that the machine-learning model can iteratively refine its ability to recognize patterns and relationships in the data.

With continued reference to FIG. 3, the operations include identifying a set of vibrational synthesis patterns 310 as a function of the aggregated vibrational data 308. As used in the current disclosure, a vibrational synthesis pattern 310 refers to a set of characteristics of a vibrational pattern associated with root causes of diagnostic issues. The set of characteristics includes both primary characteristics (i.e. frequency, amplitude, and duration of vibrations) as well as secondary characteristics (i.e., operational states, installation dates, and orientation). The vibrational synthesis pattern 310 may be used to identify the root causes of diagnostic issues. For instance, a vibrational synthesis pattern 310 might indicate that a movable barrier operator is experiencing increased amplitude within its vibrational patterns due to severe overuse of the system.

In an embodiment, generating the vibrational synthesis pattern 310 involves analyzing the aggregated vibrational data 308 to identify recurring characteristics that correlate with known diagnostic issues. Processor 102 may be configured to examine the vibrational characteristics of the aggregated vibrational data 308 to detect patterns that have previously been associated with specific mechanical issues or operational anomalies. By employing correlation analysis, Processor 102 can quantitatively measure the strength and direction of relationships between different vibrational characteristics and known mechanical problems. For instance, if a particular frequency spike is frequently recorded during instances of motor wear, the processor will quantify this relationship, determining how consistently this pattern occurs in conjunction with reported issues.

In addition to correlation analysis, clustering techniques may be employed to categorize the vibrational characteristics into distinct groups based on their similarities. This is particularly useful in identifying clusters of data points that share common features. For example, multiple instances of high-frequency vibrations may be grouped together, indicating a potential issue that affects multiple movable barrier operators 302 under similar conditions.

In an embodiment, machine-learning models may be used to generate the vibrational synthesis patterns 310. Machine-learning models may be used to process the large volumes of data associated with the aggregated vibrational data 308 to identify correlations and patterns that exist between the set of characteristics and the root causes of diagnostic issues. To train the machine-learning model, processor 102 may be configured to generate training data as a function of historical versions of the aggregated vibrational data 308 and the vibrational synthesis patterns 310. These training datasets may include labeled examples of inputs and outputs to the machine-learning model. In a non-limiting example, the training datasets may include a group of characteristics that are labeled with root causes of diagnostic issues. Using this training data, the system learns to associate certain vibrational characteristics with specific outcomes. This is done by iteratively adjusting the biases and weights associated with the machine-learning model based on the training data. This iterative training process allows the model to refine its predictions, increasing its accuracy in identifying potential problems based on the synthesized patterns derived from the aggregated data.

With continued reference to FIG. 3, the operations may include calculating an optimal vibrational threshold 312 as a function of the aggregated vibrational data 308 and/or the vibrational synthesis patterns 310. As used in the current disclosure, an optimal vibrational threshold refers to a set of predefined limits or criteria associated with vibrational characteristics that are indicative of one or more root causes of diagnostic issues. When the values of these vibrational characteristics deviate beyond/below the optimal vibrational threshold 312, they may indicate the presence of mechanical or electrical issues that require attention. The optimal vibrational threshold 312 may be determined by analyzing historical vibrational data from a variety of systems under normal operating conditions. This data is used to establish a baseline for what constitutes “normal” vibration levels for a movable barrier operator under a given set of circumstances. For example, the system might establish a threshold for the frequency or amplitude of vibrations during normal operation. Any vibrational reading that exceeds this threshold may suggest an anomaly, such as mechanical wear, motor malfunctions, or misalignment.

The optimal vibrational threshold 312 may be defined by both primary and secondary characteristics. By analyzing the aggregated vibrational data 308, the system identifies baseline values for normal operation across different conditions. For example, the system may observe typical vibrational frequencies and amplitudes during standard operations, allowing it to set thresholds that represent normal ranges. Any deviations beyond these thresholds can signal a potential mechanical or operational issue, such as motor wear or misalignment. In addition to the primary characteristics, the secondary characteristics can be used to define the optimal vibrational threshold. For instance, secondary characteristics like the system's age, the frequency of use, the environmental conditions (e.g., temperature, humidity, weather, geography), and orientation can all influence the vibrational behavior.

In some cases, the optimal vibrational threshold 312 may be a dynamic threshold. This means that the optimal vibrational threshold 312 can be iteratively adjusted based on environmental changes, system age, or usage patterns. A trend analysis, as discussed herein above, may be used to identify how the vibrational patterns change over time. This analysis may be used to identify how the optimal vibrational threshold 312 changes over time as well. In a non-limiting example, a movable barrier operator in a high-use environment might have a slightly different optimal vibrational threshold 312 compared to a system with infrequent usage, as the wear and tear on components may be more pronounced. Environmental factors such as temperature, humidity, or dust can also influence the vibrational behavior of the system and, therefore, the thresholds need to be adjusted accordingly.

When the system detects a vibrational reading that exceeds the optimal vibrational threshold 312, it may flag the potential issue and correlate it with known root causes. For example, a vibrational pattern exceeding a certain amplitude and frequency range might suggest an impending motor failure, while a long-duration vibration with low frequency could indicate problems with misalignment or bearing wear. By maintaining and continually refining the optimal vibrational thresholds, the system can proactively identify and address mechanical issues before they result in system failure or costly repairs.

To define the optimal vibrational threshold 312, machine-learning models or statistical analysis can be employed to analyze patterns in vibrational data and identify thresholds that correlate with known issues or failure modes. These machine-learning models can learn from past instances of vibration data associated with specific problems (e.g., motor wear, misalignment, or component degradation). The system can then automatically adjust and calibrate the optimal vibrational threshold 312 over time.

With continued reference to FIG. 1, the diagnostic data 118 may be generated by comparing the one or more vibrational patterns 112 with the optimal vibrational threshold 312. By comparing the observed vibrational patterns 112 of system 100 to the optimal vibrational threshold 312, the system can identify any anomalies or deviations that may indicate potential mechanical or electrical issues. When the vibrational pattern 112 exceeds or falls outside the optimal vibrational threshold 312, the system may flag it as potentially indicative of an issue. This comparison can be used to classify the potential problem based on known patterns of failure or wear. For example, if the vibrational pattern 112 shows an unusually high amplitude or frequency beyond the set threshold, diagnostic data 118 may indicate issues such as motor wear, unbalanced components, or mechanical strain. In addition, the system may use trend analysis to detect changes in vibrational behavior over time, helping to distinguish between transient anomalies and persistent, developing problems that could require maintenance.

The diagnostic data 118 generated from this comparison can include information about the nature of the issue, its potential causes, and its severity. For instance, if a pattern of high-frequency vibrations is consistently observed across several instances, the system may categorize this as a potential sign of motor stress or misalignment. In some cases, the diagnostic data 118 may include actionable insights, such as suggesting specific maintenance actions, predicting the remaining useful life of components, or recommending when repairs or replacements are needed.

In an embodiment, the processor 102 may determine the operational status of a movable barrier operator 106 as a function of the diagnostic data 118. As used in the current disclosure, the operational status refers to the current state of the system based on its performance and mechanical health. The operational status may include statuses such as normal, warning, maintenance needed, system failure, and the like. When a vibrational pattern exceeds or falls outside the optimal vibrational threshold 312, it indicates a potential anomaly that could affect the barrier's functionality. By analyzing these deviations, the system can determine the operational status of the movable barrier operator 106.

In a non-limiting example, if the vibrational pattern 112 falls within the expected range of the optimal vibrational threshold 312, the system may determine that the movable barrier operator 106 is in a normal operational state. This means that the movable barrier operator 106 is functioning as expected, with no significant mechanical or electrical issues detected. In this case, diagnostic data 118 would indicate a healthy system and no immediate maintenance actions would be required. However, if the vibrational data shows minor deviations that do not exceed the threshold but suggest potential wear or stress (e.g., slight increases in frequency or amplitude), the system might classify the status as a warning. This would signal that while the system is still operational, it is showing signs of potential degradation that may require attention in the near future to prevent failure.

If the vibrational data shows significant deviations from the optimal threshold the system would classify the operational status as system failure. This could be indicated by vibrational characteristics such as increases in amplitude, a sustained high-frequency pattern, or other severe anomalies. This indicates a more serious issue that likely affects the system's performance and could result in failure if left unaddressed. In this case, the diagnostic data 118 would provide specific insights into the likely root cause of the problem, such as motor failure, misalignment, or component damage. The system may also generate recommendations for immediate maintenance or repairs based on the operational status of the movable barrier operator 106.

### GENERATING A DIAGNOSTIC REPORT AS A FUNCTION OF THE DIAGNOSTIC DATA

With continued reference to FIG. 1, the operations may further comprise generating a diagnostic report as a function of the diagnostic data 118. As used in the current disclosure, a diagnostic report is a document that provides information about the operational status of the movable barrier operator 106 based on diagnostic data 118. The diagnostic report may be generated after analyzing various operational parameters, such as vibrational patterns, temperature, power consumption, and other relevant metrics. The diagnostic report may be used to provide insights into the current condition of the movable barrier operator 106, identify potential root cause issues, and provide recommendations for maintenance or corrective actions to prevent failures or optimize performance.

The diagnostic report may provide information associated with the movable barrier operator's 106 performance. For example, the diagnostic report may include a breakdown of vibrational frequency, amplitude, and duration over a specific period. If deviations from normal operating conditions are detected, the report may highlight these anomalies, explaining what they may signify in terms of the operational status of the movable barrier operator 106.

In an embodiment, the diagnostic report may include recommendations for maintenance or corrective actions based on the diagnostic data 118. If the diagnostic data suggests that a part of the system is experiencing wear or failure, the diagnostic report may suggest specific actions, such as lubricating moving parts, replacing worn-out components, or adjusting operational parameters to mitigate the issue. In some cases, the diagnostic report may also provide predictions regarding the system's remaining useful life, based on the rate of wear or other factors.

The diagnostic report may provide information about the severity of the root cause issues of the diagnostic data 118. The diagnostic report may include information related to the categorization of the root cause issues based on their severity. The severity of the root cause issues may range from minor issues that may require attention in the near future to critical failures that require immediate intervention.

In some cases, the diagnostic report may include information related to the trend analysis and historical diagnostic data. The diagnostic report may be used to identify patterns or trends over time, such as a gradual increase in vibration amplitude that might indicate a developing issue. Additionally, the diagnostic report may include performance comparisons with similar systems in similar environments, helping to benchmark the system's performance and identify any outliers that may require attention.

### COMPARING VIBRATIONAL PATTERNS TO A REFERENCE DATABASE OF WEATHER DATA FOR DIAGNOSTIC INSIGHTS

With continued reference to FIG. 1, the operations may include comparing information associated with the one or more vibrational patterns 112 to a reference database that comprises a plurality of weather data. As used in the current disclosure, weather data is a collection of historical and real-time weather information. The weather data may be used to assess and predict the impact of environmental conditions on movable barrier operators 10 and other mechanical systems. The reference database may include a variety of weather-related parameters, such as temperature, humidity, wind speed, rainfall, hail, snow, and other meteorological data. The weather database may include information such as time, date, and duration of the weather-related parameters.

In an embodiment, weather data may include seismic data. As used in the current disclosure, seismic data may track the vibrations caused by seismic activity such as earthquakes, ground tremors, or subsurface movements. By integrating seismic data into the reference database, the system can differentiate between vibrations caused by natural events like earthquakes and those caused by normal system operation, helping to avoid false alarms, and providing valuable insights for maintenance.

By cross-referencing the vibrational patterns 112 with this weather data, the system can determine whether changes in vibrational patterns 112 are likely due to external environmental conditions or if they signal internal mechanical issues. In a non-limiting example, if the vibrational patterns 112 indicate an unusual increase in frequency or amplitude, and the reference database shows that high winds or heavy rainfall occurred during the same time period, the system may conclude that the external weather conditions contributed to the abnormal vibrational behavior.

Similarly, if seismic activity is recorded in the reference database, and the vibrational patterns 112 show vibrations that correlate with seismic events, the system can attribute these vibrations to ground tremors rather than mechanical failure. On the other hand, if no relevant weather conditions are found to coincide with the observed anomalies, it may suggest that the cause of the vibration lies within the internal components of the movable barrier operator 106. The comparison process enables the system to identify root causes of the diagnostic data based on the relationship between environmental conditions and operational performance. By analyzing this relationship, the system can classify issues as being either weather-induced or mechanical.

### DETERMINING A CONTROL INSTRUCTION TO INITIATE A TEST CYCLE OF THE MOVABLE BARRIER OPERATOR IN RESPONSE TO THE DIAGNOSTIC DATA

With continued reference to FIG. 1, processor 102 may be instructed to perform operations that include determining a control instruction to initiate a test cycle of the movable barrier operator 106 in response to the diagnostic data 118. The control instruction may be a command signal that manages and/or regulates the operation of a system or device, such as the movable barrier operator 106. The control instruction may specify a desired action or transformation, such as engaging or disengaging a movable barrier operator 106 to affect a state of an associated movable barrier. The control instruction may also include instructions that affect control of an appliance (e.g., between on and off settings), adjusting settings, initiating a sequence of operations, and the like. When a control instruction is received at the movable barrier operator 106, processor(s) of the movable barrier operator 106 may direct a motor or actuator associated with the movable barrier operator 106 to perform the specified action, such as raising or lowering the movable barrier. Safety protocols may be embedded in the control signal that halts or pauses the movable barrier operator 106 if a blockage or failure of the movable barrier is detected, thereby preventing damage or injury. Control instructions may be issued through various interfaces, including remote controls, mobile apps, or automated systems, and are executed by the movable barrier operator.

With continued reference to FIG. 1, processor 102 may be instructed to perform operations that comprise causing communication of the control instruction to the movable barrier operator 106 to initiate the test cycle. As used in the current disclosure, a test cycle of the movable barrier operator 106 refers to a controlled sequence of operations designed to assess the functionality of the movable barrier operator 106. This cycle typically simulates the normal operating conditions of the movable barrier operator 106 by actuating the movable barrier. The test cycle may be used to gather data on the system's behavior, including its mechanical, electrical, and vibrational characteristics, which can be used to diagnose potential issues and verify the proper functioning of the operator.

During the test cycle, the movable barrier operator 106 may be subjected to actions such as opening and closing the barrier, engaging, and disengaging motors, and applying various mechanical stresses that are common during normal usage. The cycle may also include varying the speed, load, or environmental conditions (e.g., temperature, humidity) to simulate different operating environments. Sensors may be used to monitor and record data points, such as the vibrational patterns, motor performance, power consumption, and any abnormal behaviors that may indicate potential mechanical or electrical issues.

The data collected during the test cycle may be analyzed to detect any anomalies or deviations from the expected performance. For example, if the system experiences higher-than-normal vibrational amplitudes or irregular motor behavior during the cycle, it may indicate issues such as component wear, misalignment, or insufficient lubrication. The results of the test cycle can be compared to optimal vibrational threshold 312 or baseline data to determine the operational status of the system, identify potential issues, and inform maintenance or repair decisions.

With continued reference to FIG. 1, the operations may further include transmitting, by the computing system, a notification to a user device as a function of the diagnostic data. This notification may be generated based on the identification of root cause by the diagnostic data. A notification may be used to alert users to potential issues with the movable barrier operator 106. In some cases, the notification may include recommendations for monitoring or scheduling routine maintenance to prevent further issues. The notification may include details such as the affected components and suggestions for corrective action. If the diagnostic data indicates a more significant anomaly or a potential failure, the notification may be generated to advise the user to take immediate action, such as pausing operation, inspecting the system, seeking professional repair services, or performing a test cycle. The notifications may be delivered through various channels, such as push notifications, text messages, or emails. In some cases, the system may require the user to acknowledge receipt of the notification, ensuring that the issue is being addressed promptly. By delivering timely notifications based on diagnostic data, the system helps users take informed actions to maintain the optimal performance and safety of the movable barrier operator.

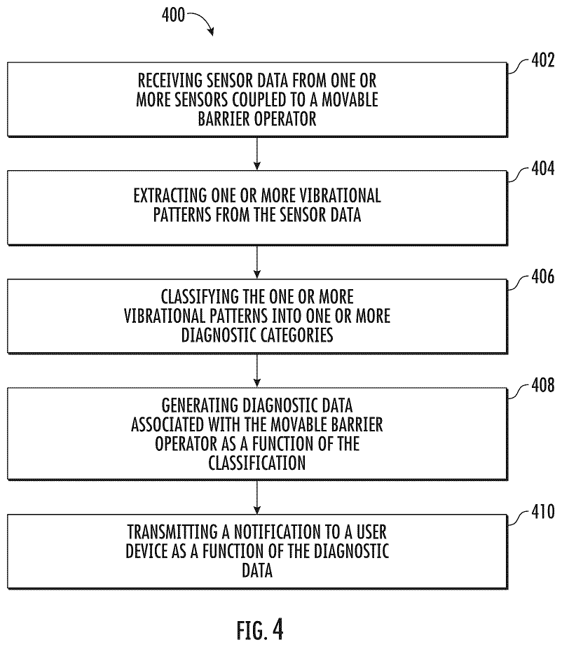

Referring now to FIG. 4, a flow diagram of a method for monitoring vibrational patterns associated with a movable barrier operator is depicted.

At step 402, the method includes receiving, by a computing system comprising one or more processors, sensor data from one or more sensors coupled to a movable barrier operator.

At step 404, the method includes extracting, by the computing system, one or more vibrational patterns from the sensor data.

At step 406, the method includes classifying, by the computing system, the one or more vibrational patterns into one or more diagnostic categories. In an embodiment, classifying the one or more vibrational patterns may include: training a vibrational model using vibrational training data, wherein the vibrational training data comprises examples of vibrational patterns correlated to examples of diagnostic categories; and classifying the one or more vibrational patterns into the one or more diagnostic categories using the trained vibrational model.

At step 408, the method includes generating, by the computing system, diagnostic data associated with the movable barrier operator as a function of the classification. In an embodiment, generating the diagnostic data may include comparing information associated with the one or more vibrational patterns to a reference database that comprises a plurality of weather data; and identifying one or more root causes of the diagnostic data as a function of the comparison.

In an additional embodiment, classifying the one or more vibrational patterns comprises: generating a set of diagnostic scores as a function of the one or more vibrational patterns; and classifying the one or more vibrational patterns as a function of the set of diagnostic scores.

In some cases, generating the diagnostic data may include: generating aggregated vibrational data as a function of a set of vibrational patterns generated from a plurality of remote sensors; identifying a set of vibrational synthesis patterns as a function of the aggregated vibrational data, wherein each vibrational synthesis pattern of the set of vibrational synthesis patterns is associated with at least one root cause of the diagnostic data; and wherein classifying the one or more vibrational patterns further comprises classifying the one or more vibrational patterns to at least one vibrational synthesis pattern of the plurality of vibrational synthesis patterns.

The method may additionally include generating, by the computing system, a diagnostic report as a function of the diagnostic data.

At step 410, the method includes transmitting, by the computing system, a notification to a user device as a function of the diagnostic data.

In an embodiment, the method may further include determining, by the computing system, a control instruction to initiate a test cycle of the movable barrier operator in response to the diagnostic data; causing communication of the control instruction to the movable barrier operator to initiate the test cycle of the movable barrier operator; receiving, by the computing system, a second set of vibrational patterns as a function of the test cycle; and verifying, by the computing system, the diagnostic data as a function of the second set of vibrational patterns.

Further aspects of the invention are provided by one or more of the following embodiments:

Embodiment 1. A computing system for monitoring a movable barrier operator, the system comprising: a movable barrier operator coupled to one or more sensors; one or more processors; and one or more non-transitory computer-readable media that collectively store instructions that, when executed by the one or more processors, cause the computing system to perform operations, the operations comprising: receiving sensor data from the one or more sensors; extracting one or more vibrational patterns from the sensor data; classifying the one or more vibrational patterns into one or more diagnostic categories; generating diagnostic data associated with the movable barrier operator as a function of the classification; and transmitting a notification to a user device as a function of the diagnostic data.

Embodiment 2. The system of embodiment 1, wherein classifying the one or more vibrational patterns comprises: training a vibrational model using vibrational training data, wherein the vibrational training data comprises examples of vibrational patterns correlated to examples of diagnostic categories; and classifying the one or more vibrational patterns into the one or more diagnostic categories using the trained vibrational model.

Embodiment 3. The system of embodiment 1, wherein generating the diagnostic data comprises: comparing information associated with the one or more vibrational patterns to a reference database that comprises a plurality of weather data; and identifying one or more root causes of the diagnostic data as a function of the comparison.

Embodiment 4. The system of embodiment 1, wherein generating the diagnostic data comprises: generating aggregated vibrational data as a function of a set of vibrational patterns generated from a plurality of remote sensors; and identifying a set of vibrational synthesis patterns as a function of the aggregated vibrational data.

Embodiment 5. The system of embodiment 1, wherein the operations further comprise: determining a control instruction to initiate a test cycle of the movable barrier operator in response to the diagnostic data; and causing communication of the control instruction to the movable barrier operator to initiate the test cycle of the movable barrier operator.

Embodiment 6. The system of embodiment 1, wherein classifying the one or more vibrational patterns comprises: generating a set of diagnostic scores as a function of the one or more vibrational patterns; and classifying the one or more vibrational patterns as a function of the set of diagnostic scores.

Embodiment 7. The system of embodiment 1, wherein the operations further comprise determining an operational status of a movable barrier in response to the diagnostic data.

Embodiment 8. A method for monitoring a movable barrier operator, the method comprising: receiving, by a computing system comprising one or more processors, sensor data from one or more sensors coupled to a movable barrier operator; extracting, by the computing system, one or more vibrational patterns from the sensor data; classifying, by the computing system, the one or more vibrational patterns into one or more diagnostic categories; generating, by the computing system, diagnostic data associated with the movable barrier operator as a function of the classification; and transmitting, by the computing system, a notification to a user device as a function of the diagnostic data.

Embodiment 9. The method of embodiment 8, wherein classifying the one or more vibrational patterns comprises: training a vibrational model using vibrational training data, wherein the vibrational training data comprises examples of vibrational patterns correlated to examples of diagnostic categories; and classifying the one or more vibrational patterns into the one or more diagnostic categories using the trained vibrational model.

Embodiment 10. The method of embodiment 8, wherein generating the diagnostic data comprises: comparing information associated with the one or more vibrational patterns to a reference database that comprises a plurality of weather data; and identifying one or more root causes of the diagnostic data as a function of the comparison.

Embodiment 11. The method of embodiment 8, wherein generating the diagnostic data comprises: generating aggregated vibrational data as a function of a set of vibrational patterns generated from a plurality of remote sensors; identifying a set of vibrational synthesis patterns as a function of the aggregated vibrational data, wherein each vibrational synthesis pattern of the set of vibrational synthesis patterns is associated with at least one root cause of the diagnostic data; and wherein classifying the one or more vibrational patterns further comprises classifying the one or more vibrational patterns to at least one vibrational synthesis pattern of the plurality of vibrational synthesis patterns.

Embodiment 12. The method of embodiment 8, wherein the method further comprises: determining, by the computing system, a control instruction to initiate a test cycle of the movable barrier operator in response to the diagnostic data; causing communication of the control instruction to the movable barrier operator to initiate the test cycle of the movable barrier operator; receiving, by the computing system, a second set of vibrational patterns as a function of the test cycle; and verifying, by the computing system, the diagnostic data as a function of the second set of vibrational patterns.

Embodiment 13. The method of embodiment 8, wherein classifying the one or more vibrational patterns comprises: generating a set of diagnostic scores as a function of the one or more vibrational patterns; and classifying the one or more vibrational patterns as a function of the set of diagnostic scores.

Embodiment 14. The method of embodiment 8, wherein the method further comprises generating, by the computing system, a diagnostic report as a function of the diagnostic data.

Embodiment 15. A computing system for monitoring a movable barrier operator, the system comprising: a movable barrier operator coupled to one or more sensors; one or more processors; and one or more non-transitory computer-readable media that collectively store instructions that, when executed by the one or more processors, cause the computing system to perform operations, the operations comprising: receiving sensor data from the one or more sensors; extracting one or more vibrational patterns from the sensor data; classifying the one or more vibrational patterns into one or more diagnostic categories, wherein classifying the one or more vibrational patterns comprises: iteratively training a vibrational model using vibrational training data, wherein the vibrational training data comprises examples of vibrational patterns correlated to examples of diagnostic categories; and classifying the one or more vibrational patterns into the one or more diagnostic categories using the trained vibrational model; generating diagnostic data associated with the movable barrier operator as a function of the classification; and transmitting a notification to a user device as a function of the diagnostic data.

Embodiment 16. The system of embodiment 15, wherein generating the diagnostic data comprises: generating aggregated vibrational data as a function of a set of vibrational patterns generated from a plurality of remote sensors; calculating an optimal vibrational threshold as a function of the aggregated vibrational data; comparing the one or more vibrational patterns to the optimal vibrational threshold; and generating the diagnostic data as a function of the comparison of the one or more vibrational patterns to the optimal vibrational threshold.

Embodiment 17. The system of embodiment 15, wherein generating the diagnostic data comprises: comparing information associated with the one or more vibrational patterns to a reference database that comprises a plurality of seismic data; and identifying one or more root causes of the diagnostic data as a function of the comparison.

Embodiment 18. The system of embodiment 15, wherein the operations further comprise: determining a control instruction to initiate a test cycle of the movable barrier operator in response to the diagnostic data; and causing communication of the control instruction to the movable barrier operator to initiate the test cycle of the movable barrier operator.

Embodiment 19. The system of embodiment 18, wherein the operations further comprise determining an operational status of the movable barrier as a function of the test cycle.

Embodiment 20. The system of embodiment 15, wherein the operations further comprise generating a diagnostic report as a function of the diagnostic data, wherein the diagnostic report comprises a time-domain analysis.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A computing system for monitoring a movable barrier operator, the system comprising:
a movable barrier operator coupled to one or more sensors;
one or more processors; and
one or more non-transitory computer-readable media that collectively store instructions that, when executed by the one or more processors, cause the computing system to perform operations, the operations comprising:
receiving sensor data from the one or more sensors;
extracting one or more vibrational patterns from the sensor data;
classifying the one or more vibrational patterns into one or more diagnostic categories;
generating diagnostic data associated with the movable barrier operator as a function of the classification; and
transmitting a notification to a user device as a function of the diagnostic data.

2. The system of claim 1, wherein classifying the one or more vibrational patterns comprises:
training a vibrational model using vibrational training data, wherein the vibrational training data comprises examples of vibrational patterns correlated to examples of diagnostic categories; and
classifying the one or more vibrational patterns into the one or more diagnostic categories using the trained vibrational model.

3. The system of claim 1, wherein generating the diagnostic data comprises:
comparing information associated with the one or more vibrational patterns to a reference database that comprises a plurality of weather data; and
identifying one or more root causes of the diagnostic data as a function of the comparing.

4. The system of claim 1, wherein generating the diagnostic data comprises:
generating aggregated vibrational data as a function of a set of vibrational patterns generated from a plurality of remote sensors; and
identifying a set of vibrational synthesis patterns as a function of the aggregated vibrational data.

5. The system of claim 1, wherein the operations further comprise:
determining a control instruction to initiate a test cycle of the movable barrier operator in response to the diagnostic data; and
causing communication of the control instruction to the movable barrier operator to initiate the test cycle of the movable barrier operator.

6. The system of claim 1, wherein classifying the one or more vibrational patterns comprises:
generating a set of diagnostic scores as a function of the one or more vibrational patterns; and
classifying the one or more vibrational patterns as a function of the set of diagnostic scores.

7. The system of claim 1, wherein the operations further comprise determining an operational status of a movable barrier in response to the diagnostic data.

8. A method for monitoring a movable barrier operator, the method comprising:
receiving, by a computing system comprising one or more processors, sensor data from one or more sensors coupled to a movable barrier operator;
extracting, by the computing system, one or more vibrational patterns from the sensor data;
classifying, by the computing system, the one or more vibrational patterns into one or more diagnostic categories;
generating, by the computing system, diagnostic data associated with the movable barrier operator as a function of the classification; and
transmitting, by the computing system, a notification to a user device as a function of the diagnostic data.

9. The method of claim 8, wherein classifying the one or more vibrational patterns comprises:
training a vibrational model using vibrational training data, wherein the vibrational training data comprises examples of vibrational patterns correlated to examples of diagnostic categories; and
classifying the one or more vibrational patterns into the one or more diagnostic categories using the trained vibrational model.

10. The method of claim 8, wherein generating the diagnostic data comprises:
comparing information associated with the one or more vibrational patterns to a reference database that comprises a plurality of weather data; and
identifying one or more root causes of the diagnostic data as a function of the comparing.

11. The method of claim 8, wherein generating the diagnostic data comprises:
generating aggregated vibrational data as a function of a set of vibrational patterns generated from a plurality of remote sensors;
identifying a set of vibrational synthesis patterns as a function of the aggregated vibrational data, wherein each vibrational synthesis pattern of the set of vibrational synthesis patterns is associated with at least one root cause of the diagnostic data; and
wherein classifying the one or more vibrational patterns further comprises classifying the one or more vibrational patterns to at least one vibrational synthesis pattern of a plurality of vibrational synthesis patterns.

12. The method of claim 8, wherein the method further comprises:
determining, by the computing system, a control instruction to initiate a test cycle of the movable barrier operator in response to the diagnostic data; and
causing communication of the control instruction to the movable barrier operator to initiate the test cycle of the movable barrier operator.

13. The method of claim 8, wherein classifying the one or more vibrational patterns comprises:
generating a set of diagnostic scores as a function of the one or more vibrational patterns; and
classifying the one or more vibrational patterns as a function of the set of diagnostic scores.

14. The method of claim 8, wherein the method further comprises generating, by the computing system, a diagnostic report as a function of the diagnostic data.

15. A computing system for monitoring a movable barrier operator, the system comprising:
a movable barrier operator coupled to one or more sensors;
one or more processors; and
one or more non-transitory computer-readable media that collectively store instructions that, when executed by the one or more processors, cause the computing system to perform operations, the operations comprising:
receiving sensor data from the one or more sensors;
extracting one or more vibrational patterns from the sensor data;
classifying the one or more vibrational patterns into one or more diagnostic categories, wherein classifying the one or more vibrational patterns comprises:
iteratively training a vibrational model using vibrational training data, wherein the vibrational training data comprises examples of vibrational patterns correlated to examples of diagnostic categories; and
classifying the one or more vibrational patterns into the one or more diagnostic categories using the trained vibrational model;
generating diagnostic data associated with the movable barrier operator as a function of the classification; and
transmitting a notification to a user device as a function of the diagnostic data.

16. The system of claim 15, wherein generating the diagnostic data comprises:
generating aggregated vibrational data as a function of a set of vibrational patterns generated from a plurality of remote sensors;
calculating an optimal vibrational threshold as a function of the aggregated vibrational data;
comparing the one or more vibrational patterns to the optimal vibrational threshold; and
generating the diagnostic data as a function of the comparing.

17. The system of claim 15, wherein generating the diagnostic data comprises:
comparing information associated with the one or more vibrational patterns to a reference database that comprises a plurality of seismic data; and
identifying one or more root causes of the diagnostic data as a function of the comparing.

18. The system of claim 15, wherein the operations further comprise:
determining a control instruction to initiate a test cycle of the movable barrier operator in response to the diagnostic data; and
causing communication of the control instruction to the movable barrier operator to initiate the test cycle of the movable barrier operator.

19. The system of claim 18, wherein the operations further comprise determining an operational status of the movable barrier as a function of the test cycle.

20. The system of claim 15, wherein the operations further comprise generating a diagnostic report as a function of the diagnostic data.
